(19) United States
(12) Patent Application Publication
(10) Pub. No.: US 2025/0185119 A1
(43) Pub. Date: Jun. 5, 2025

(54) COMMUNICATION METHOD, CENTRAL UNIT AND DISTRIBUTED UNIT

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/048,456

(22) Filed: Feb. 7, 2025

Related U.S. Application Data
(63) Continuation of application No. PCT/JP2023/028757, filed on Aug. 7, 2023.
(60) Provisional application No. 63/395,933, filed on Aug. 8, 2022.

(51) Int. Cl. H04W 76/40; H04W 76/10

(52) U.S. Cl. CPC H04W 76/40; H04W 76/10

(57) ABSTRACT

A communication method used in a mobile communication system providing a multicast/broadcast service (MBS) includes transmitting, by a central unit included in a base station, MBS-related information to a distributed unit included in the base station over a network interface between the central unit and the distributed unit. The MBS-related information is information on a user equipment that is receiving or is interested in receiving an MBS service provided by a secondary cell subordinate to the distributed unit.

### RELATED APPLICATIONS

The present application is a continuation based on PCT Application No. PCT/JP2023/028757, filed on Aug. 7, 2023, which claims the benefit of U.S. Provisional Patent Application No. 63/395,933 filed on Aug. 8, 2022. The content of which is incorporated by reference herein in their entirety.

### TECHNICAL FIELD

The present disclosure relates to a communication method, a central unit, and a distributed unit for use in a mobile communication system.

### BACKGROUND

In the 3rd Generation Partnership Project (3GPP), a technical specification of New Radio (NR) that is radio access technology of the fifth generation (5G) is defined. NR has characteristics such as high speed, large capacity, high reliability, and low latency, in comparison to Long Term Evolution (LTE) that is radio access technology of the fourth generation (4G). In 3GPP, a technical specification of a multicast/broadcast service (MBS) of 5G/NR is defined (for example, see Non-Patent Document 1).

### CITATION LIST

### Non-Patent Literature

Non-Patent Document 1: 3GPP technical specification: TS 38.300 V17.1.0

### SUMMARY

A communication method according to a first aspect is a communication method used in a mobile communication system providing a multicast/broadcast service (MBS), the communication method including transmitting, by a central unit included in a base station, MBS-related information to a distributed unit included in the base station over a network interface between the central unit and the distributed unit. The MBS-related information is information on a user equipment that is receiving or is interested in receiving an MBS service provided by a secondary cell subordinate to the distributed unit.

A central unit according to a second aspect is a central unit included in a base station in a mobile communication system providing a multicast/broadcast service (MBS), the central unit including a transmitter configured to transmit MBS-related information to a distributed unit included in the base station over a network interface between the central unit and the distributed unit. The MBS-related information is information on a user equipment that is receiving or is interested in receiving an MBS service provided by a secondary cell subordinate to the distributed unit.

A distributed unit according to a third aspect is a distributed unit included in a base station in a mobile communication system providing a multicast/broadcast service (MBS), the distributed unit includes a receiver configured to receive MBS-related information from a central unit included in the base station over a network interface between the central unit and the distributed unit. The MBS-related information is information on a user equipment that is receiving or is interested in receiving an MBS service provided by a secondary cell subordinate to the distributed unit.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a wireless interface of a user plane handling data.

FIG. 5 is a diagram illustrating a configuration of a protocol stack of a wireless interface of a control plane handling signaling (control signal).

FIG. 6 is a diagram illustrating an overview of an operation of the mobile communication system according to an embodiment.

FIG. 7 is a diagram illustrating a first operation example of the mobile communication system according to the embodiment.

FIG. 8 is a diagram illustrating a second operation example of the mobile communication system according to the embodiment.

### DESCRIPTION OF EMBODIMENTS

A mobile communication system according to an embodiment will be described with reference to the drawings. In the description of the drawings, the same or similar parts are denoted by the same or similar reference signs.

### (1) Configuration of Mobile Communication System

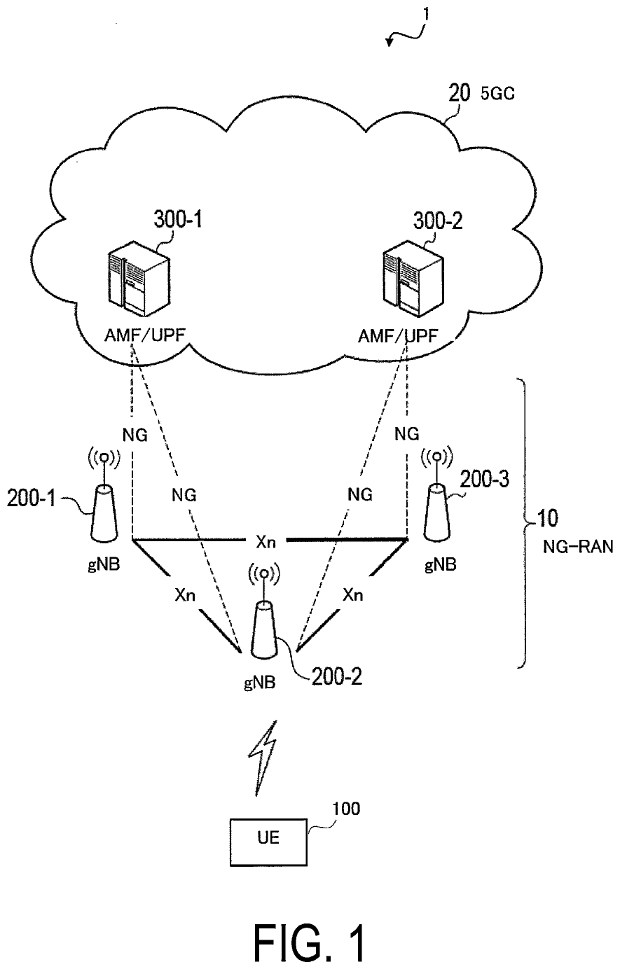

FIG. 1 is a diagram illustrating a configuration of a mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes a User Equipment (UE) 100, a 5G radio access network (NG-RAN: Next Generation Radio Access Network) 10, and a 5G Core Network (5GC) 20. Hereinafter, the NG-RAN 10 may be simply referred to as a RAN 10. Further, the 5GC 20 may be simply referred to as a core network (CN) 20.

The UE 100 is a mobile wireless communication device. The UE 100 may be any device as long as the UE 100 is used by a user. The UE 100 is, for example, a mobile phone terminal (including a smartphone) and/or a tablet terminal, a notebook PC, a communication module (including a communication card or a chipset), a sensor or a device provided on the sensor, a vehicle or a device provided on the vehicle (Vehicle UE), or a flying object or a device (Aerial UE) provided on the flying object.

The NG-RAN 10 includes a base station (referred to as “gNB” in a 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

The gNB can also be connected to an Evolved Packet Core (EPC) that is to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

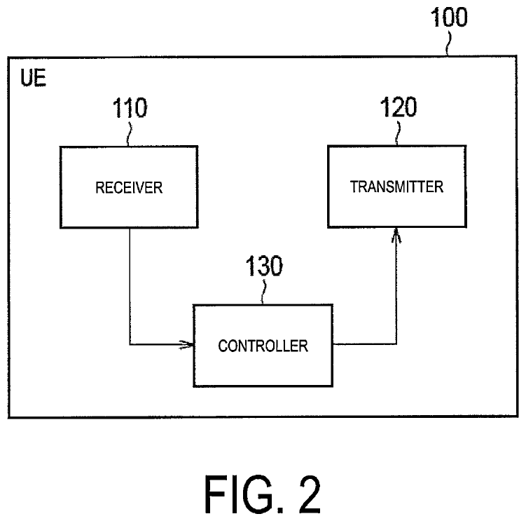

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

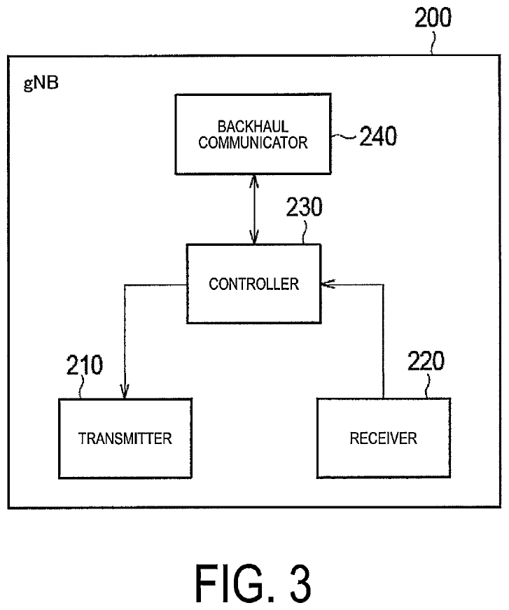

FIG. 3 is a diagram illustrating a configuration of the gNB 200 (base station) according to an embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via a NG interface between a base station and the core network. The gNB 200 may include a Central Unit (CU) and a Distributed Unit (DU) (that is, functions are divided), and both the units may be connected via an F1 interface that is a fronthaul interface.

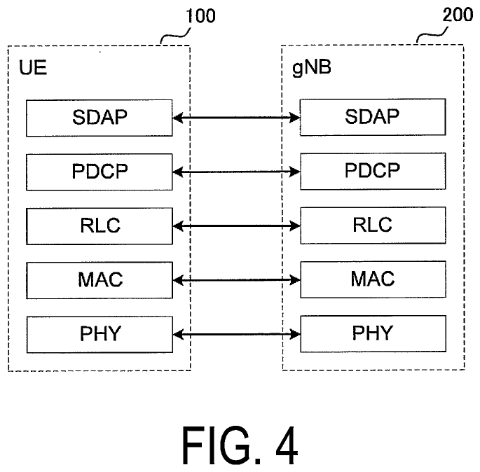

FIG. 4 is a diagram illustrating a configuration of a protocol stack of a wireless interface of a user plane that handles data.

A wireless interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

A PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. The PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

An SDAP layer performs mapping between an IP flow as the unit of Quality of Service (QoS) control performed by a core network and a radio bearer as the unit of QoS control performed by an Access Stratum (AS). When the RAN is connected to the EPC, SDAP need not be provided.

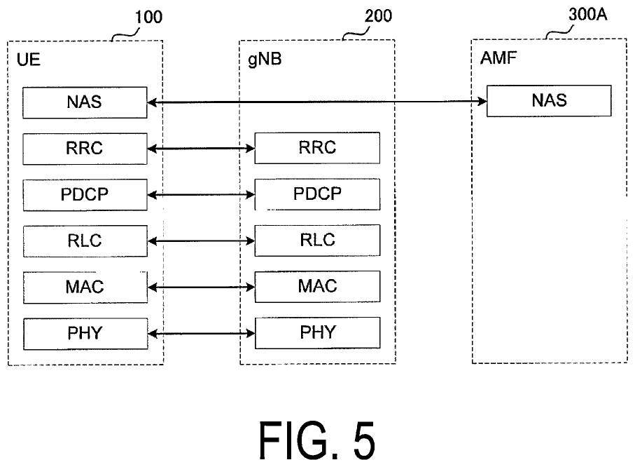

FIG. 5 is a diagram illustrating a configuration of a protocol stack of a wireless interface of a control plane that handles signaling (a control signal).

The protocol stack of the wireless interface of the control plane includes a Radio Resource Control (RRC) layer and a Non-Access Stratum (NAS) layer instead of SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer located higher than the RRC layer performs session management, mobility management, and the like. NAS signaling is transferred between the NAS layer of the UE 100 and the NAS layer of an AMF 300A. The UE 100 includes an application layer other than the protocol of the wireless interface. A layer lower than the NAS layer is referred to as an AS layer.

### (2) Overview of MBS

The mobile communication system 1 can perform delivery with high resource efficiency through multicast/broadcast service (MBS).

In the case of a broadcast communication service (also referred to as “MBS broadcast”), the same service and the same specific content data are provided simultaneously to all UEs 100 within a geographic area. That is, all the UEs 100 in the broadcast service area are permitted to receive data. The broadcast communication service is delivered to the UE 100 using a broadcast session, which is a type of MBS session. The UE 100 can receive the broadcast communication service in any of the RRC idle state, the RRC inactive state, and the RRC connected state.

In the case of a multicast communication service (also referred to as “MBS multicast”), the same service and the same specific content data are simultaneously provided to a specific set of UEs. That is, not all the UEs 100 in the multicast service area are permitted to receive the data. The multicast communication service is delivered to the UE 100 using a multicast session, which is a type of MBS session. The UE 100 can receive multicast communication services in the RRC connected state using a mechanism such as Point-to-Point (PTP) and/or Point-to-Multipoint (PTM) delivery. The UE 100 may receive the multicast communication service in an RRC inactive (or RRC idle) state.

Hereinafter, the MBS broadcast will mainly be described. However, the embodiments are not limited to the MBS broadcast and are applicable to MBS multicast.

The UE 100 in the RRC idle state, the RRC inactive state, or the RRC connected state receives an MBS configuration (for example, parameters required for MTCH reception) for a broadcast session through an MCCH. Parameters (MCCH configuration) required for reception of the MCCH are provided through system information. Specifically, a system information block type 20 (SIB20) includes the MCCH configuration. An SIB type 21 includes information on service continuity of MBS broadcast reception. The MCCH provides a list of all broadcast services including ongoing sessions transmitted on an MTCH, and related information of the broadcast session includes an MBS session ID, related G-RNTI scheduling information, and information on neighboring cells providing a specific service on the MTCH.

In order to secure service continuity of an MBS broadcast, the UE 100 in the RRC connected state can transmit, to the gNB 200 providing SIB21, an MBS Interest Indication (MII) message that is the RRC message including the following information:
List of MBS frequencies that the UE is interested in receiving;
Priority between reception of all listed MBS frequencies and reception of unicast bearers; and
A list of MBS broadcast services (service IDs) that the UE 100 is interested in receiving (when SIB20 is scheduled on PCell of the UE 100).

The transmission of the MBS interest indication message may be implicitly enabled/disabled due to the presence of SIB21.

When the gNB 200 provides RRC configuration and/or downlink assignment to the UE 100, the UE 100 may enable the UE 100 to receive an MBS service in which the UE 100 is interested based on the MBS Interest Indication message.

### (3) Overview of Carrier Aggregation

In an embodiment, for the UE 100, the carrier aggregation (CA) is configured by the gNB 200. In the CA, a plurality of component carriers (CCs) corresponding to a plurality of serving cells are aggregated, so that the UE 100 can simultaneously perform reception or transmission over the plurality of CCs. The plurality of CCs may be contiguous in a frequency direction. The plurality of CCs may be non-contiguous.

When the CA is configured, there is only one RRC connection with the network (for example, gNB 200) in the UE 100. For RRC connection establishment/re-establishment/handover, one serving cell provides NAS mobility information, and for RRC connection re-establishment/handover, one serving cell provides a security input. The one serving cell is referred to as a primary cell (PCell). The primary cell is an MCG cell operating at a primary frequency at which the UE 100 performs an initial connection establishment procedure or initiates a connection re-establishment procedure. When the UE 100 receives an RRC setup message from a cell in the initial connection establishment procedure, the UE 100 regards the cell as a primary cell. A set of serving cells can be formed by configuring a secondary cell (SCell) for the UE 100 together with a PCell. Accordingly, a set of serving cells configured for the UE 100 includes one PCell and one or more SCells. Reconfiguration, addition, and deletion of SCells can be performed by RRC.

A cell activation/deactivation mechanism is supported so that power consumption of the UE 100 can be curbed when the CA is configured. When SCell is deactivated, the UE 100 does not need to receive the corresponding PDCCH or PDSCH and does not need to execute the corresponding uplink and/or CQI measurement. On the other hand, when SCell is active, the UE 100 may receive the PDSCH and PDCCH and perform CQI measurement.

When one or more SCells are configured in the UE 100, the gNB 200 may activate and deactivate the configured SCells. At the time of configuration of the SCell, the SCell is deactivated unless the RRC parameter “sCellState” is configured to be active for the SCell. The configured SCell is activated and deactivated in the following methods:
The UE 100 receives the SCell Activation/Deactivation MAC CE from the gNB 200;
The gNB 200 configures the RRC parameter “sCellDeactivationTimer” timer for each configured SCell; The UE 100 deactivates the corresponding SCell upon expiry of the timer;
The gNB 200 configures a parameter “sCellState” of the RRC for each configured SCell; and
When the parameter is configured, the UE 100 activates the corresponding SCell at the time of SCell configuration.

The UE 100 can receive an MBS broadcast date and MCCH from the PCell or one SCell at a certain timing. UE-dedicated RRC signaling may be used to provide SIB20 of SCell.

### (4) Operation of Mobile Communication System

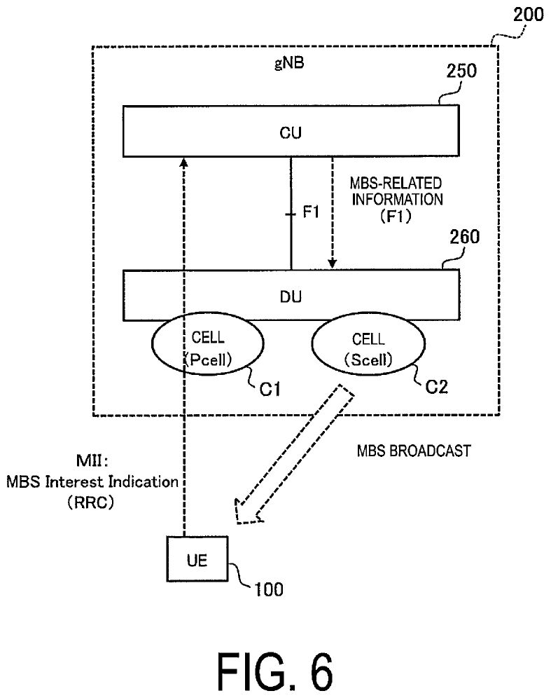

FIG. 6 is a diagram illustrating an overview of an operation of the mobile communication system 1 according to an embodiment.

In the embodiment, the gNB 200 the gNB 200 is functionally divided into a Central Unit (CU) 250 and a Distributed Unit (DU) 260. Although FIG. 6 illustrates an example in which the number of DUs 260 is one, the number of DUs 260 may be two or more. Each of the CU 250 and DU 260 may have a hardware configuration as illustrated in FIG. 3.

The CU 250 is a logical node including the RRC, SDAP, and PDCP layers (protocols) of the gNB 200. The CU 250 controls an operation of the DU. The CU 250 is connected to the DU 260 via the F1 interface, which is a fronthaul interface. The CU is connected to an adjacent base station via an Xn interface, which is an interface between base stations.

The DU 260 is a logical node including the RLC, MAC and PHY layers (protocols) of the gNB 200. The DUs 260 form one or more cells. Although FIG. 6 illustrates an example in which there are two cells formed by the DU 260, that is, two cells (cell C1 and cell C2) subordinate to the DU 260, there may be two or more cells subordinate to the DU 260.

In such an operation scenario, it is assumed that the UE 100 configured with the carrier aggregation by the gNB 200 is receiving or interested in receiving an MBS service (for example, MBS broadcast) provided in the cell C2. Here, the cell C1 is the PCell of the UE 100 and the cell C2 is the SCell of the UE 100.

As described above, the gNB 200 can activate/deactivate the SCell by transmitting the SCell Activation/Deactivation MAC CE to the UE 100. Since the MAC-layer is included in the DU 260, the DU 260 transmits the SCell Activation/Deactivation MAC CE to the UE 100.

However, since the MII message is an RRC message and is transmitted from the UE 100 to the CU 250 on the RRC layer, the DU 260 cannot ascertain the content of the MII message. Therefore, the DU 260 cannot ascertain that the UE 100 is receiving or is interested in receiving the MBS broadcast provided in the cell C2. Thus, the DU 260 may deactivate the SCell by transmitting an SCell Deactivation MAC CE to the UE 100. There is a problem in that, when the SCell is deactivated, the UE 100 cannot receive the MBS broadcast provided in the cell C2. Further, such a problem may occur not only in the case of the MBS broadcast but also in the case of the MBS multicast.

Thus, in an embodiment, the CU 250 transmits the MBS-related information to the DU 260 over the F1 interface between the CU 250 and the DU 260. The MBS-related information is information on the UE 100 that is receiving or is interested in receiving the MBS service (for example, MBS broadcast) provided by the SCell (cell C2) subordinate to the DU 260. Since this makes it possible for the DU 260 to perform SCell activation/deactivation in consideration of the MBS interest of the UE 100, it is possible to improve service continuity in the UE 100. In the embodiment, the term “MBS service” mainly refers to an MBS broadcast, but may also refer to an MBS multicast.

The CU 250 may transmit a UE Context Setup Request message including the MBS-related information or a UE Context Modification Request message including the MBS-related information to the DU 260. These messages are the F1 messages associated with the UE 100 and are suitable for transmission of the MBS-related information.

The CU 250 receives the MBS interest indication (MII), which is an RRC message, from the UE 100. The CU 250 transmits the MBS-related information to the DU 260 based on the MBS interest indication (MII).

The DU 260 determines activation and deactivation of the SCell for the UE 100 based on the MBS-related information received from the CU 250. The DU 260 may transmit the SCell Activation/Deactivation MAC CE, which is a medium access control and control element (MAC CE) indicating an activation instruction or a deactivation instruction of the SCell, to the UE 100 according to a result of the determination.

In an embodiment, the MBS-related information transmitted from the CU 250 to the DU 260 may be information indicating whether to request the activation of the SCell. The MBS-related information may include information indicating a reason for the request.

The MBS-related information transmitted from the CU 250 to the DU 260 may include at least one of:
information indicating an MBS service that the UE 100 is receiving or is interested in receiving (for example, a service ID such as a TMGI);
information indicating an MBS frequency that the UE 100 is receiving or is interested in receiving; or
information on a cell providing the MBS service or MBS frequency (for example, a cell ID).

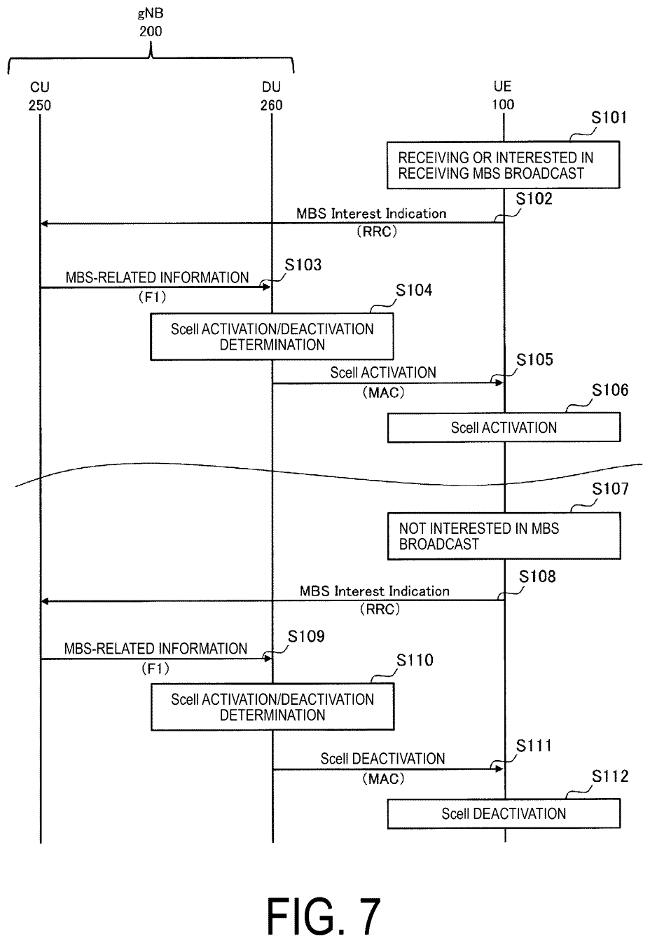

FIG. 7 is a diagram illustrating a first operation example of the mobile communication system 1 according to the embodiment. In the present operation example, the CU 250 transmits at least a part of the MII received from the UE 100 to the DU 260 as the MBS-related information.

In step S101, the UE 100 is receiving or interested in receiving an MBS service (for example, an MBS broadcast) provided in a cell C2 (SCell).

In step S102, the UE 100 transmits MII to the CU 250. As described above, the MII includes information of an MBS service of interest (TMGI), information of an MBS frequency of interest, and information of reception priority of unicast and MBS. The CU 250 receives the MII. In the case of the MBS multicast, the CU 250 may receive information included in the MII from the core network instead of receiving the MII from the UE 100.

In step S103, the CU 250 transmits a UE Context Setup Request message or a UE Context Modification Request message including the MBS-related information to the DU 260 over the F1 interface. The MBS-related information includes information (TMGI) of MBS service in which the UE 100 is interested and/or information of MBS frequencies in which the UE 100 is interested. The MBS-related information may include a cell ID and/or a frequency identifier of a cell (cell C2) providing an MBS service in which the UE 100 is interested. Alternatively, the MBS-related information may include cell-IDs and/or frequency identifiers of cells that is not to be deactivated (that is, remain active) because the UE 100 is interested in MBS reception.

In step S104, the DU 260 identifies the cell C2 (SCell) providing an MBS service in which the UE 100 is interested, based on the MBS-related information from the CU 250. The DU 260 may identify a cell (SCell) that does not provide the MBS service in which the UE 100 is interested. The DU 260 may identify a cell (SCell) providing an MBS service in which the UE 100 is no longer interested. The DU 260 determines the activation/deactivation of the SCell.

In step S105, the DU 260 transmits the SCell Activation/Deactivation MAC CE to the UE 100 as needed. Here, the DU 260 activates the cell C2 (SCell) providing the MBS service in which the UE 100 is interested. The DU 260 may activate/deactivate the SCell not providing the MBS service in which the UE 100 is interested, according to a traffic situation of unicast transmission. Here, the description will be given on the assumption that the DU 260 instructs the UE 100 to activate the cell C2 (SCell).

In step S106, the UE 100 activates the cell C2 (SCell) according to an instruction of the DU 260 in step S105.

Then, in step S107, the UE 100 is no longer interested in the MBS service (for example, MBS broadcast).

In step S108, the UE 100 notifies the CU 250 that the UE 100 is no longer interested in the MBS service using an MII. In the case of the MBS multicast, the CU 250 may receive, from the core network, information indicating that the UE 100 is no longer interested in the MBS service.

In step S109, the CU 250 transmits a UE Context Setup Request message or a UE Context Modification Request message including MBS-related information reflecting the MII of step S108 to the DU 260. The message may include information of a cell in which deactivation is possible (permitted).

In step S110, the DU 260 determines whether to deactivate the cell C2 (SCell) based on the MBS-related information from the CU 250. Here, description will be given on the assumption that the cell C2 (SCell) is determined to be deactivated.

In step S111, the DU 260 transmits an SCell Deactivation MAC CE to the UE 100.

In step S112, the UE 100 deactivates the SCell in response to receiving the SCell Deactivation MAC CE in step S111.

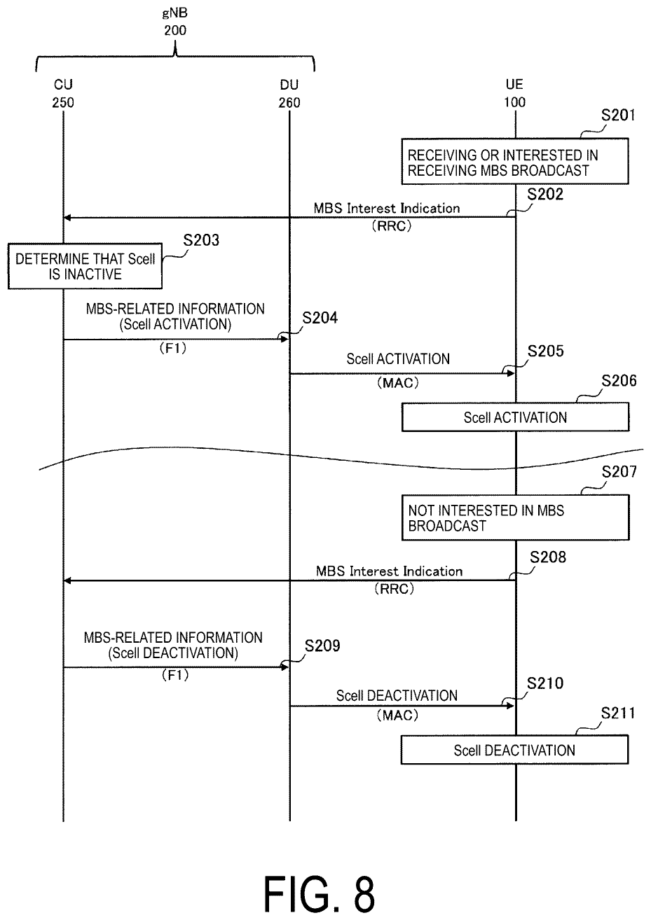

FIG. 8 is a diagram illustrating a second operation example of the mobile communication system 1 according to the embodiment. In the present operation example, the CU 250 transmits a request based on the MII received from the UE 100 to the DU 260. Redundant description of an operation that overlaps with the first operation example described above will be omitted.

In step S201, the UE 100 is receiving or interested in receiving an MBS service (for example, an MBS broadcast) provided in the cell C2 (SCell).

In step S202, the UE 100 transmits the MII to the CU 250. In the case of the MBS multicast, the CU 250 may receive information included in the MII from the core network instead of receiving the MII from the UE 100.

In step S203, the CU 250 identifies the SCell providing the MBS service based on the MII (or information received from the core network). Here, it is assumed that the CU 250 has identified that the identified SCell is in an inactive state.

In step S204, the CU 250 transmits, to the DU 260, the UE Context Setup Request message or the UE Context Modification Request message including the MBS-related information indicating a request for SCell activation to the DU 260. The message includes at least one of:
Cell ID of a cell to be activated;
Cause: Information indicating that the UE 100 is interested in receiving an MBS service (for example, MBS broadcast);
TMGI: An identifier indicating an MBS service to which SCell activation is applied; or
MBS frequency: Identifier indicating a frequency at which the UE 100 is interested in receiving the MBS service (for example, MBS broadcast).

In step S205, the DU 260 activates (or maintains activation of) the SCell requested to be activated by the CU 250 in step S204. The DU 260 may transmit an SCell Activation MAC CE to the UE 100 to activate the SCell, if necessary. The UE 100 activates the SCell (step S206). The DU 260 may return a response to the CU 250 on the F1 interface after the SCell is activated. In such a situation, deactivation of the SCell may be restricted in the DU 260.

Then, in step S207, the UE 100 is no longer interested in the MBS service (for example, MBS broadcast).

In step S208, the UE 100 transmits to the CU 250 an MII indicating that the UE 100 is no longer interested in the MBS service. In the case of the MBS multicast, the CU 250 may receive, from the core network, information indicating that the UE 100 is no longer interested in the MBS service.

In step S209, the CU 250 transmits an F1 message including MBS-related information indicating release of maintenance of the SCell active state (that is, deactivation permission) based on the MII of step S208 (or information received from the core network). The content (item) of the information is the same as or similar to that in step S204. The DU 260 deactivates the SCell of which restriction has been released, if necessary (steps S210 and S211).

### (5) Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although an example in which the base station is an NR base station (that is, gNB) has been described in the embodiments and the examples described above; the base station may be an LTE base station (that is, an eNB) or a 6G base station. Further, the base station may be a relay node such as an Integrated Access and Backhaul (IAB) node. The base station may be a DU of the IAB node. Further, the UE 100 may be a Mobile Termination (MT) of the IAB node.

A program for causing a computer to execute each of the processing performed by the UE 100 or the gNB 200 (CU 250 and DU 260) may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Further, circuits for executing processing performed by the UE 100 or the gNB 200 may be integrated, and at least a part of the UE 100 or the gNB 200 (CU 250 and DU 260) may be configured as a semiconductor integrated circuit (a chipset or System on a chip (SoC)).

The phrases “based on” and “depending on/in response to” used in the present disclosure do not mean “based only on” and “only depending on/in response to,” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design changes and the like can be made without departing from the gist of the present disclosure.

### (6) Supplements

Characteristics regarding the embodiments described above are described below as supplements.

### Supplement 1

A communication method used in a mobile communication system providing a multicast/broadcast service (MBS), the communication method including transmitting, by a central unit included in a base station, MBS-related information to a distributed unit included in the base station over a network interface between the central unit and the distributed unit, wherein the MBS-related information is information on a user equipment that is receiving or is interested in receiving an MBS service provided by a secondary cell subordinate to the distributed unit.

### Supplement 2

The communication method according to supplement 1, wherein the network interface is an F1 interface, and the transmitting the MBS-related information includes transmitting a UE Context Setup Request message including the MBS-related information or a UE Context Modification Request message including the MBS-related information to the distributed unit.

### Supplement 3

The communication method according to supplement 1 or 2, further including receiving, by the central unit, an MBS interest indication from the user equipment, the MBS interest indication being a radio resource control (RRC) message, wherein the transmitting the MBS-related information includes transmitting the MBS-related information to the distributed unit based on the MBS interest indication.

### Supplement 4

The communication method according to any one of supplements 1 to 3, further including determining, by the distributed unit, activation and deactivation of the secondary cell for the user equipment, based on the MBS-related information received from the central unit.

### Supplement 5

The communication method according to supplement 4, further including transmitting, by the distributed unit, a medium access control and control element (MAC CE) indicating an activation instruction or a deactivation instruction of the secondary cell to the user equipment according to a result of the determination.

### Supplement 6

The communication method according to any one of supplements 1 to 5, wherein the MBS-related information is information indicating whether activation of the secondary cell is requested.

### Supplement 7

The communication method according to supplement 6, wherein the MBS-related information includes information indicating a reason for the request.

### Supplement 8

The communication method according to any one of supplements 1 to 7, wherein the MBS-related information includes at least one selected from the group consisting of information indicating an MBS service that the user equipment is receiving or is interested in receiving, information indicating an MBS frequency that the user equipment is receiving or is interested in receiving, and information on a cell providing the MBS service or the MBS frequency.

### Supplement 9

A central unit included in a base station in a mobile communication system providing a multicast/broadcast service (MBS), the central unit including a transmitter configured to transmit MBS-related information to a distributed unit included in the base station over a network interface between the central unit and the distributed unit, wherein the MBS-related information is information on a user equipment that is receiving or is interested in receiving an MBS service provided by a secondary cell subordinate to the distributed unit.

### Supplement 10

A distributed unit included in a base station in a mobile communication system providing a multicast/broadcast service (MBS), the distributed unit including a receiver configured to receive MBS-related information from a central unit included in the base station over a network interface between the central unit and the distributed unit, wherein the MBS-related information is information on a user equipment that is receiving or is interested in receiving an MBS service provided by a secondary cell subordinate to the distributed unit.

### REFERENCE SIGNS

1: Mobile communication system
10: RAN
20: CN
100: UE (User equipment)
110: Receiver
120: Transmitter
130: Controller
200: gNB (base station)
210: Transmitter
220: Receiver
230: Controller
240: Backhaul communicator
250: CU (central unit)
260: DU (distributed unit)

1. A communication method used in a mobile communication system providing a multicast/broadcast service (MBS), the communication method comprising:
transmitting, by a central unit comprised in a base station, MBS-related information to a distributed unit comprised in the base station over a network interface between the central unit and the distributed unit, wherein
the MBS-related information is information on an MBS service that a user equipment in a cell of the distributed unit is receiving or is interested in receiving.

2. The communication method according to claim 1, wherein
the network interface is an F1 interface, and
the transmitting the MBS-related information comprises transmitting a UE Context Setup Request message comprising the MBS-related information or a UE Context Modification Request message comprising the MBS-related information to the distributed unit.

3. The communication method according to claim 1, further comprising:
receiving, by the central unit, an MBS interest indication from the user equipment, the MBS interest indication being a radio resource control (RRC) message, wherein
the transmitting the MBS-related information comprises transmitting the MBS-related information to the distributed unit based on the MBS interest indication.

4. The communication method according to claim 1, wherein
the MBS-related information comprises at least one selected from the group consisting of information indicating an MBS service that the user equipment is receiving or is interested in receiving, information indicating an MBS frequency that the user equipment is receiving or is interested in receiving, and information on a cell providing the MBS service or the MBS frequency.

5. A central unit comprised in a base station in a mobile communication system providing a multicast/broadcast service (MBS), the central unit comprising:
a transmitter configured to transmit MBS-related information to a distributed unit comprised in the base station over a network interface between the central unit and the distributed unit, wherein
the MBS-related information is information on an MBS service that a user equipment in a cell of the distributed unit is receiving or is interested in receiving.

6. A distributed unit comprised in a base station in a mobile communication system providing a multicast/broadcast service (MBS), the distributed unit comprising:
a receiver configured to receive MBS-related information from a central unit comprised in the base station over a network interface between the central unit and the distributed unit, wherein
the MBS-related information is information on an MBS service that a user equipment in a cell of the distributed unit is receiving or is interested in receiving.
